(19) United States
(12) Patent Application Publication
(10) Pub. No.: US 2006/0236569 A1
(43) Pub. Date: Oct. 26, 2006

(54) Business cardfolio

(75) Inventor: Charla Freeman Puryear, Brooklyn, NY (US)

Correspondence Address: Charla F. Puryear, 96 Warren Street, Brooklyn, NY, 11201, US

(73) Assignee: Charla F. Puryear, Brooklyn, NY (US)

(21) Appl. No.: 11/112,912

(22) Filed: Apr. 25, 2005

(51) Int. Cl. G09F 1/00

(52) U.S. Cl. 40/124.13

(57) ABSTRACT

The Business Cardfolio is a business card that serves the dual purpose of providing contact information and a visual reminder of the card owner's work. The card has a face and four or more fold-out panels that enable the card owner to display visuals and/or text, within the shape and relative size of a traditional business card. The card provides the card owner with sufficient space to present a “mini-portfolio,” and conventional contact information, along with additional information about the images displayed on the business card, or resume or other marketing information about him/herself. The card also provides the recipient with writing space for notations.

### TITLE AND FIELD OF THE INVENTION

The present invention is called the Business Cardfolio and it relates generally to printed matter; more specifically to such matter having revealable information, and more particularly, to a means of providing examples from a professional's portfolio or body of work, as part of a business card.

### GENERAL BACKGROUND OF THE INVENTION

Wallet-sized cards bearing printed information upon one face, typically including a person's name and or the name of a firm or company, physical and/or electronic communications contact information, company logo or other brand identifying information, etc., herein known as “traditional business cards,” are well known. It is considered that the primary purpose of a business card is to provide a ready reference to a prospective business associate or other entity who may want to contact the person in the future. Traditional business cards are typically carried in a wallet or other holder, routinely carried on one's person.

### DISCUSSION OF PRIOR ART

The following four U.S. patents deal with business cards or business-oriented greeting cards:

| U.S. Pat. | | | |
|---|---|---|---|
| No. | Inventor | Date | Title of Invention |
| 4,838,580 | Tuhkanen | Feb. 17, 1987 | Combined Business Card |
| | | | and Brochure |
| 4,907,826 | Versage | Mar. 13, 1990 | Business Oriented |
| | | | Greeting Cards |
| 5,522,622 | Segar | Jun. 4, 1996 | Greeting Cards and |
| | | | Method for Displaying |
| | | | Same |
| 5,887,899 | Dobbins | Mar. 30, 1999 | Convertible Business |
| | | | Card |

Tuhkanen discloses a sheet with a perforated panel comprising a “visiting” or business card detachable from a folded package including a “brochure” and held in packet form by two opposed tabs, each having adhesive upon one face. Versage discloses a “greeting card comprising a piece of card stock and a unitary message imprinted thereon,” said message comprising a pun appropriate for sending between related parties “in a professional or business way.” The card has a fold line dividing the card into two “pages,” both bearing a portion of a “unitary message,” the entirety of which is only visible with the card open. Segar discloses a greeting card having a central fold dividing the card into front and back panels. The reverse surface of the back panel has a portion covered by adhesive and a moveable cover for the same which may be disposed in a position which exposes the adhesive. Dobbins discloses a card with a printed face, a back, and a fold that divides the card into a main portion and a flap that is foldable over the fold line, so that the back of the flap is flush with the back of the main portion and the face of the card has the shape and appearance of a traditional business card. An adhesive layer is disposed on the back of the card so that, with the flap open, the adhesive may be exposed and the card removably adhered to a smooth vertical surface, juxtaposing the face of the flap and an auxilliary message printed on the same with the face of the main portion. Removal of the card from the surface and either folding the flap or separating the flap from the main portion converts the card back to one which has the shape and appearance of a traditional business card.

### STATEMENT OF NEED

Frequently, especially with regard to people in professions that involve visual arts, the recipient of the traditional business card, who may review countless forms of art (defined as visual image of any kind) and may receive hundreds of traditional business cards from prospective clients or suppliers, will have difficulty recalling a specific card owner's work. Therefore, it is useful and desirable to have a visual reminder of the nature, appearance, format and/or other visual aspects of the card owner's work for convenient and easy reference. It is further considered desirable for this reminder to be of such size and shape as to make it simple to use, portable, and requiring no unusual or extraordinary accommodations other than those already in use to store or carry traditional business cards. Finally, it is useful and desirable for the card owner to be able to show examples of his/her work at unplanned meetings or other informal encounters. Thus, a need is considered to exist for this additional capability.

### SUMMARY OF THE INVENTION

### Objects of the Invention

The primary object of the invention is a business card that serves the dual purpose of providing contact information for future use and a visual reminder of the card owner's work.

An ancillary object of the present invention is such a business card that contains all of the necessary contact information, as well as the inclusion of additional visuals, in the shape and relative size of a traditional business card.

Another subsidiary object of the present invention is such a business card that provides the card owner with sufficient space to present a “mini-portfolio,” and conventional contact information, along with additional information about the images displayed on the business card, or resume or other marketing information about him/herself.

A further subsidiary object of the present invention is such a business card that provides the recipient with additional writing space for notations.

### Principles Relating to the Present Invention

The Business Cardfolio is printed, optimally on business card stock (80 lb. paper). Other weights of paper can be used. In an embodiment of the invention, the face has the shape and appearance of a traditional business card. The face panel of the Cardfolio extends to include a fold-out consisting of eight panels (four front, four back), and is folded in the manner of an accordion. The panels of the fold-out are of the same size and shape as the card face, which contains the contact information. Visual images of the card owner's work, products or services are printed on the fold-out panels. Images and/or words may be printed on the front of the panels, as well as on the back of the panels.

### BRIEF DESCRIPTION OF THE DRAWINGS

FIG. 1 is a plain view taken from the front of an embodiment of the principles relating to the present invention depicting a business card with fold-outs that extend behind the face 1 of the card, allowing for the inclusion of visual and/or text representations of the card owner's work.

FIG. 2 is a plain view taken from the rear of the card depicted in FIG. 1.

FIG. 3 is a ¾ view taken from the right side front of the card depicted in FIG. 1.

FIG. 4 is a ¾ view taken from the left side front of the card depicted in FIG. 1.

FIG. 5 is a ¾ view taken from the right side rear of the card depicted in FIG. 1.

FIG. 6 is a ¾ view taken from the left side rear of the card depicted in FIG. 1.

FIG. 7 is a side view of the card depicted in FIG. 1 in its folded (compressed) state.

FIG. 8 is a side view of the card depicted in FIG. 1, with the panels partially extended.

FIG. 9 is a view of the printed side of one of the fold-out panels of the card depicted in FIG. 1.

FIG. 10 is a view of an unprinted side of one of the fold-out panels of the card depicted in FIG. 1.

FIG. 11 is a front view of an embodiment of the Business Cardfolio, fully extended.

FIG. 12 is a rear view of an embodiment of the Business Cardfolio, fully extended.

### DETAILED DESCRIPTION OF THE EMBODIMENTS

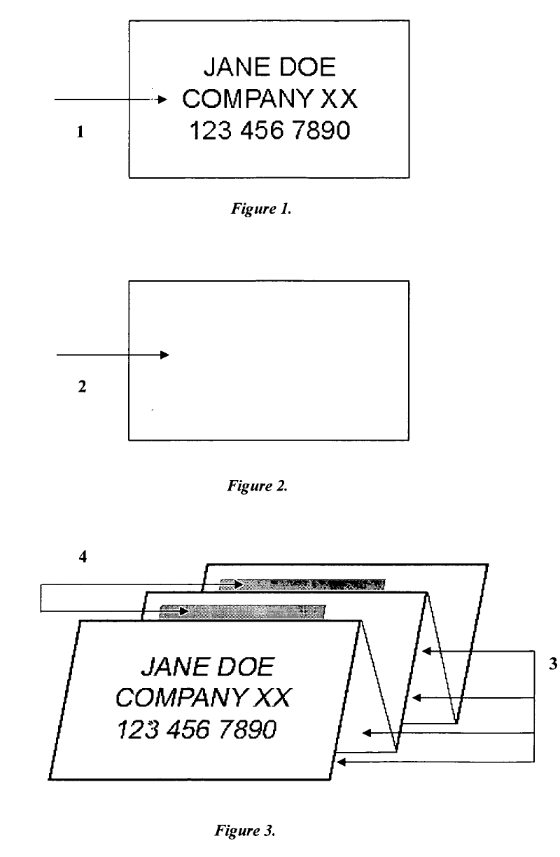

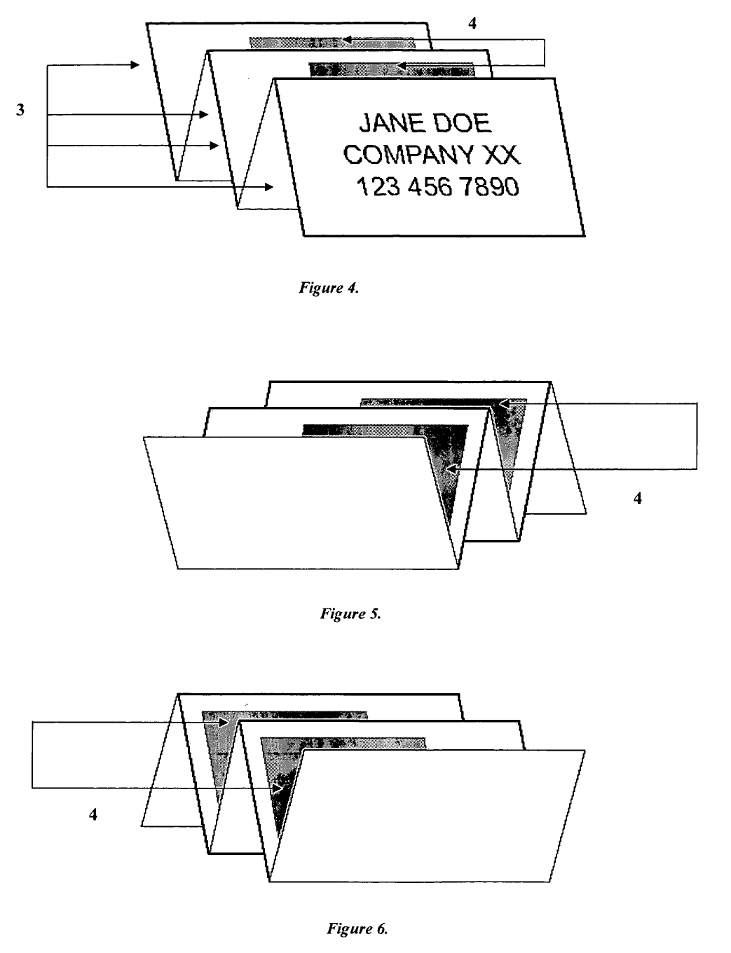

FIGS. 1 & 2 depict the front and rear of an embodiment of the Business Cardfolio in its compressed state. The fold-out panels and their contents 3 are not visible in the compressed state, unless the business card owner has utilized the rear of the card to display images or information 4 & 5.

FIGS. 3 & 4 depict a ¾ front view of the Business Cardfolio in a partially extended state. In this state, the fold-out panels and the images and/or information 4 & 5 they contain, are visible in a horizontal position.

FIGS. 5 & 6 depict a ¾ rear view of the Business Cardfolio in a partially extended state. In this state, the fold-out panels and the images and/or information 3 they contain, are visible in a horizontal position.

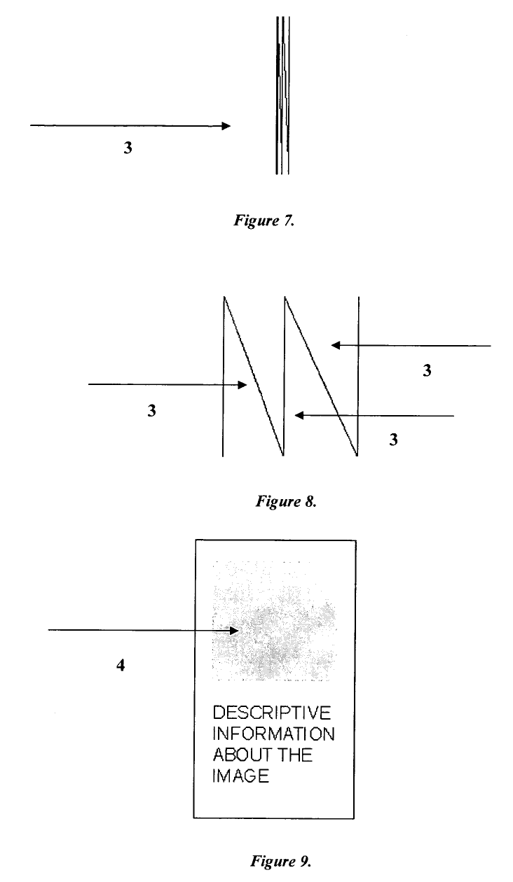

FIG. 7 depicts a side view of the Business Cardfolio in a compressed state. In this state, the fold-out panels 4 & 5 are not visible. The images contained on the panels cannot be viewed when the Business Cardfolio is in the compressed state.

FIG. 8 depicts a side view of the Business Cardfolio in a partially extended state. In this view, the images contained on the fold-out panels can be viewed.

FIG. 9 depicts a view of one of the fold-out panels 4 with images and/or other information printed on it 3. In this view, the images and/or other information contained on the fold-out panel are completely visible, fulfilling the purpose of the Business Cardfolio.

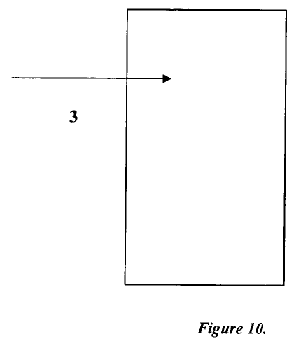

FIG. 10 depicts a view of one of the fold-out panels 4 with no image or other information printed on it. Typically, this would be a rear view of the panel, as the front is intended to contain graphic or descriptive information about the cardowner's work or services. The rear of the fold-out panel can, however, contain image and/or other information, as well. These panels can be printed on either or both sides.

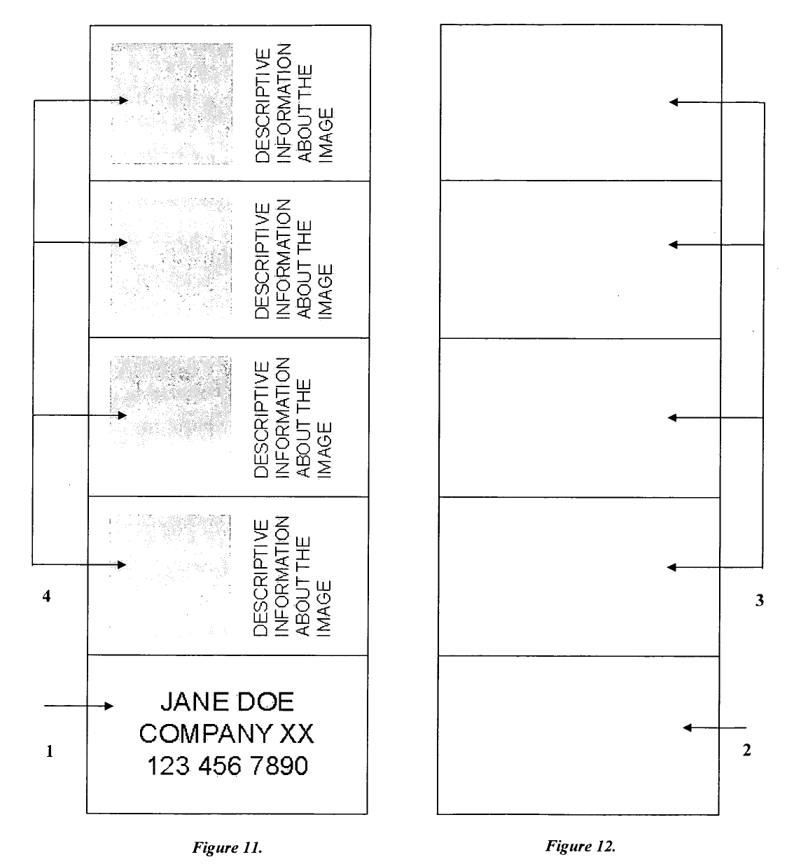

FIG. 11 depicts a front view of the Business Cardfolio with all of its panels 4 fully extended. In this view, all of the information printed on the front side of each panel is visible, as is the cardowner traditional business card contact information.

FIG. 12 depicts a rear view of the Business Cardfolio with all of its panels fully extended. In this view, the panels 4 are blank, if the cardowner has chosen not to display any additional information on the back sides of the panels.

The foregoing is intended to provide a description of the best manner of making and using a device in accordance with the principles relating to the present invention and is neither restrictive in any manner of the scope of the material encompassed by or the rights and privileges conferred by granting of Letter Patent, for which I hereby claim:

1. A piece of printed matter manufactured from card stock, comprising:
a card:
said card having a face, which bears textual information
said face being part of a continuous piece of the card stock, which is configured as a series of two or more fold-out panels, where each panel is attached along an edge to the edge of the adjacent panel(s)
said fold-out panels being able to contain information or visual images

2. A card in accordance with claim 1 wherein the face of said card resembles a conventional business card in size and shape.

3. A card, in accordance with claim 1 where there are two or more fold-out panels that extend behind the face of the card, also in the same size and shape of a conventional business card.

4. A card, in accordance with claim 1 where said fold-out panels can be printed with images or information depicting or describing a cardowner's work, products or services.
